(19) United States
(12) Patent Application Publication
(10) Pub. No.: US 2022/0330738 A1
(43) Pub. Date: Oct. 20, 2022

(54) AN IMPROVED COMBINATION COOKWARE SYSTEM

(71) Applicant: Proclamation Goods Co., San Francisco, CA (US)

(72) Inventors: Christopher Burrage, San Francisco, CA (US); Anthony Leo, San Francisco, CA (US); Philip Rose, San Francisco, CA (US)

(21) Appl. No.: 17/635,979

(22) PCT Filed: Aug. 18, 2020
(86) PCT No.: PCT/IB2020/057777

§ 371 Date: Feb. 16, 2022

Related U.S. Application Data
(60) Provisional application No. 62/888,859, filed on Aug. 19, 2019.

(51) Int. Cl. A47J 27/13; A47J 37/10; A47J 45/06; A47J 36/02

(52) U.S. Cl. CPC A47J 27/13; A47J 37/10; A47J 45/061; A47J 36/02

(57) ABSTRACT

The present disclosure relates to an improved combination cookware system having two components that can be used individually or coupled together so as to be used jointly.

### FIELD OF THE DISCLOSURE

The present disclosure relates to a cookware system. More particularly, the present disclosure relates to an improved combination cookware system having two components that can be used individually or together.

### BACKGROUND

Conventional cookware systems typically include two or more separate and discrete pieces, each having a dedicated cooking function (e.g., skillet for sautéing, a sauce pan for boiling, etc.). However, because conventional cookware systems include multiple pieces, significant space is required to store all of the pieces of the cookware system. Additionally, each piece in a cookware system is typically made of the same material, though this may not be optimal for the cooking function associated with each piece.

To overcome the issues of conventional cookware systems, combination cookware systems have been developed. Combination cookware systems typically include a skillet and a sauté pan, which together may create a dutch oven. However, since each piece in the combination cookware system is typically made of the same material, the combination cookware system is as limited in function as a conventional cookware system having individual dedicated pieces. Further, ergonomics are not considered in the design of typical combination cookware systems, as two hands are typically necessary to lift the skillet (“lid”) from the sauté pan in order to check the progress of the food cooking inside a dutch oven so formed.

Accordingly, there exists a need for an improved combination cookware system.

### SUMMARY

Generally, the disclosure is directed to versatile combination cookware systems having two components that can be used individually or coupled together so as to be used jointly. The components may be coupled together by a pivoting joint or the like to assist in the handling and use of the cookware.

In one aspect, the disclosure relates to a combination cookware system. The system includes a first portion and a second portion. The first portion has a cooking surface, a raised edge extending downwardly from and about a perimeter of the cooking surface, a gripping handle engaged with and extending outwardly from the raised edge, and a pivot handle engaged with and extending outwardly from the raised edge opposite to the gripping handle, wherein a bottom surface of the pivot handle defines a bearing stud. The second portion is configured to engage with the first portion and includes a cooking surface, a raised edge extending upwardly from and about a perimeter of the cooking surface, a gripping handle engaged with and extending outwardly from the raised edge, and a pivot handle engaged with and extending outwardly from the raised edge opposite to the gripping handle, wherein a top surface of the pivot handle defines a bearing socket configured to engage the bearing stud of the first portion pivot handle to form a pivoting joint. The pivot handles of the first and second portions are arranged to pivotably engage each other such that movement of the gripping handle of the first portion relative to the gripping handle of the second portion transitions the cookware system between a closed configuration and an open configuration.

In another aspect, the disclosure relates to an apparatus for cooking. The apparatus includes a cooking surface, a raised edge extending upwardly from and about a perimeter of the cooking surface, a gripping handle engaged with and extending outwardly from the raised edge, and a pivot handle engaged with and extending outwardly from the raised edge opposite to the gripping handle, where a top surface of the pivot handle comprises a bearing socket configured to pivotably engage a bearing stud to form a pivoting joint. The apparatus may be referred to as a pan or a hybrid pot.

In still another aspect, the disclosure relates to another apparatus for cooking. The apparatus includes a cooking surface, a raised edge extending upwardly from and about a perimeter of the cooking surface, a gripping handle engaged with and extending outwardly from the mised edge, and a pivot handle engaged with and extending outwardly from the mised edge opposite to the gripping handle, where a bottom surface of the pivot handle comprises a bearing stud configured to pivotably engage a bearing socket to form a pivoting joint.

In various embodiments of the foregoing aspects, the gripping handles of the first and second portions may be configured to nest with each other to form a unified gripping handle. For example, in certain embodiments, the gripping handle of the second portion has a longitudinal recess extending along at least a portion of a top surface of the gripping handle, and the gripping handle of the first portion has a longitudinal protuberance extending along at least a portion of a bottom surface of the gripping handle. The protuberance may be configured to engage with the recess in the gripping handle of the second portion. In some embodiments, the gripping handle of the first portion engages with the gripping handle of the second portion via a snap-fit. Also, the gripping handle of the first portion may have a length greater than a length of the gripping handle of the second portion. In various embodiments, the pivot handles of the first and second portions may pivotably engage via at least one of a ball and socket joint, a saddle joint, a hinge joint, a gliding joint, or a condyloid joint.

In additional embodiments, the raised edge of the first portion engages the raised edge of the second portion in a closed configuration. For example, engagement of the first portion with the second portion may form a dutch oven in the closed configuration. In various embodiments, the first portion may be a skillet and the second portion may be a pan. Additionally, the first and second portions may include corresponding circular shapes, corresponding polygonal shapes, or some combination of circular and polygonal as long as the shapes are corresponding, such that the raised edges of each portion generally align when in a closed configuration. The cookware system may also include a lid configured to engage at least one of the raised edge of the first portion opposite to the cooking surface, the raised edge of the second portion opposite to the cooking surface, or both simultaneously.

In further embodiments, the first portion comprises a first material and the second portion comprises a second material. The first material may include at least one of carbon steel, cast iron, multi-ply stainless steel with an aluminum core, a ferrous metal with stainless steel cladding, or combinations thereof. The second material may include at least one of carbon steel, cast iron, multi-ply stainless steel with an aluminum core, a ferrous metal with stainless steel cladding, or combinations thereof. In some embodiments, the first and second materials are different materials. For example, in one embodiment, the first material may include carbon steel, while the second material may include a multi-ply stainless steel, with or without an aluminum core. In some embodiments, both portions are made of the same material.

The present disclosure thus includes, without limitation, the following example embodiments: Example Embodiment 1: A combination cookware system comprising: a first portion comprising: a cooking surface; a raised edge extending downwardly from and about a perimeter of the cooking surface; a gripping handle engaged with and extending outwardly from the raised edge; and a pivot handle engaged with and extending outwardly from the raised edge opposite to the gripping handle, wherein a bottom surface of the pivot handle comprises a bearing stud; a second portion configured to engage with the first portion and comprising: a cooking surface; a raised edge extending upwardly from and about a perimeter of the cooking surface; a gripping handle engaged with and extending outwardly from the raised edge; a pivot handle engaged with and extending outwardly from the raised edge opposite to the gripping handle, wherein a top surface of the pivot handle comprises a bearing socket configured to engage the bearing stud of the first portion pivot handle to form a pivoting joint; wherein the pivot handles of the first and second portions are arranged to pivotably engage each other such that movement of the gripping handle of the first portion relative to the gripping handle of the second portion transitions the cookware system between a closed configuration and an open configuration.

Example Embodiment 2: An apparatus for cooking comprising: a cooking surface; a raised edge extending upwardly from and about a perimeter of the cooking surface; a gripping handle engaged with and extending outwardly from the raised edge; and a pivot handle engaged with and extending outwardly from the raised edge opposite to the gripping handle, wherein a top surface of the pivot handle comprises a bearing socket configured to pivotably engage a bearing stud to form a pivoting joint. The apparatus can serve as the first or second portion of example embodiment 1.

Example Embodiment 3: An apparatus for cooking comprising: a cooking surface; a raised edge extending upwardly from and about a perimeter of the cooking surface; a gripping handle engaged with and extending outwardly from the raised edge; and a pivot handle engaged with and extending outwardly from the raised edge opposite to the gripping handle, wherein a bottom surface of the pivot handle comprises a bearing stud configured to pivotably engage a bearing socket to form a pivoting joint. The apparatus can serve as the first or second portion of example embodiment 1.

Example Embodiment 4: The apparatus or system of any preceding example embodiment, or combinations thereof, wherein the gripping handles of the first and second portions are configured to nest with each other to form a unified gripping handle Example Embodiment 5: The apparatus or system of any preceding example embodiment, or combinations thereof, wherein the raised edge of the first portion engages the raised edge of the second portion in a closed configuration.

Example Embodiment 6: The apparatus or system of any preceding example embodiment, or combinations thereof, wherein the first portion is a skillet.

Example Embodiment 7: The apparatus or system of any preceding example embodiment, or combinations thereof, wherein the second portion is a pan. In some embodiments, the pan may also be referred to as a pot or “hybrid pot.”

Example Embodiment 8: The apparatus or system of any preceding example embodiment, or combinations thereof, wherein engagement of the first portion and the second portion forms a dutch oven in the closed configuration.

Example Embodiment 9: The apparatus or system of any preceding example embodiment, or combinations thereof, wherein the pivot handles of the first and second portions pivotably engage via at least one of a ball and socket joint, a saddle joint, a hinge joint, a gliding joint, or a condyloid joint.

Example Embodiment 10: The apparatus or system of any preceding example embodiment, or combinations thereof, wherein the gripping handle of the second portion comprises a longitudinal recess extending along at least a portion of a top surface of the gripping handle Example Embodiment 11: The apparatus or system of any preceding example embodiment, or combinations thereof, wherein the gripping handle of the first portion comprises a longitudinal protuberance extending along at least a portion of a bottom surface of the gripping handle, the protuberance configured to engage with the recess in the gripping handle of the second portion.

Example Embodiment 12: The apparatus or system of any preceding example embodiment, or combinations thereof, wherein the gripping handle of the first portion engages with the gripping handle of the second portion via a snap-fit.

Example Embodiment 13: The apparatus or system of any preceding example embodiment, or combinations thereof, wherein the gripping handle of the first portion has a length greater than a length of the gripping handle of the second portion.

Example Embodiment 14: The apparatus or system of any preceding example embodiment, or combinations thereof, comprising a lid configured to engage at least one of the raised edge of the first portion opposite to the cooking surface, the raised edge of the second portion opposite to the cooking surface, or both simultaneously.

Example Embodiment 15: The apparatus or system of any preceding example embodiment, or combinations thereof, wherein the first portion comprises a first material and the second portion comprises a second material.

Example Embodiment 16: The apparatus or system of any preceding example embodiment, or combinations thereof, wherein the first material comprises at least one of carbon steel, cast iron, multi-ply stainless steel with an aluminum core, a ferrous metal with stainless steel cladding, or combinations thereof and the second material comprises at least one of carbon steel, cast iron, multi-ply stainless steel with an aluminum core, a ferrous metal with stainless steel cladding, or combinations thereof.

Example Embodiment 17: The apparatus or system of any preceding example embodiment, or combinations thereof, wherein the first and second materials are different materials.

Example Embodiment 18: The apparatus or system of any preceding example embodiment, or combinations thereof, wherein the first material comprises carbon steel and the second material comprises a multi-ply stainless steel.

Example Embodiment 19: The apparatus or system of any preceding example embodiment, or combinations thereof, wherein the first and second portions comprise corresponding circular shapes.

Example Embodiment 20: The apparatus or system of any preceding example embodiment, or combinations thereof, wherein the first and second portions comprise corresponding polygonal shapes.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure, regardless of whether such features or elements are expressly combined or otherwise recited in a specific embodiment description herein. This disclosure is intended to be read holistically such that any separable features or elements of the disclosure, in any of its aspects and embodiments, should be viewed as intended, namely to be combinable, unless the context of the disclosure clearly dictates otherwise.

It will be appreciated that the summary herein is provided merely for purposes of summarizing some example aspects so as to provide a basic understanding of the disclosure. As such, it will be appreciated that the above described example aspects are merely examples and should not be construed to narrow the scope or spirit of the disclosure in any way. It will be appreciated that the scope of the disclosure encompasses many potential aspects, some of which will be further described below, in addition to those herein summarized. Further, other aspects and advantages of such aspects disclosed herein will become apparent from the following detailed description taken in conjunction with the accompanying drawings which illustrate, by way of example, the principles of the described aspects.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the disclosure and are not intended as a definition of the limits of the disclosure. For purposes of clarity, not every component may be labeled in every drawing. In the following description, various embodiments of the present disclosure are described with reference to the following drawings, in which:

FIG. 1 is a schematic rear perspective view of a combination cookware system in a closed configuration in accordance with one or more embodiments of the present disclosure;

FIG. 2 is a schematic side view of the combination cookware system of FIG. 1;

FIG. 3 is a schematic front view of the combination cookware system of FIG. 1;

FIG. 4 is a schematic rear view of the combination cookware system of FIG. 1;

FIG. 5 is a schematic bottom perspective view of one portion of a combination cookware system in accordance with one or more embodiments of the present disclosure;

FIG. 6 is a schematic top perspective view of another portion of a combination cookware system in accordance with one or more embodiments of the present disclosure;

FIG. 7A is a schematic side view of an engagement portion of a combination cookware system in accordance with one or more embodiments of the present disclosure;

FIGS. 7B-7C are schematic perspective views of two of the components of the engagement portion of FIG. 7A;

FIG. 8 is a pictorial representation of a combination cookware system in an open position in accordance with one or more embodiments of the present disclosure; and

FIG. 9 is a pictorial representation of an alternative combination cookware system in an open position in accordance with one or more embodiments of the present disclosure.

### DETAILED DESCRIPTION OF PREFERRED EMBODIMENTS

Various implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a”, “an”, and “the” mean “one or more,” unless specified otherwise or clear from context to be directed to a singular form.

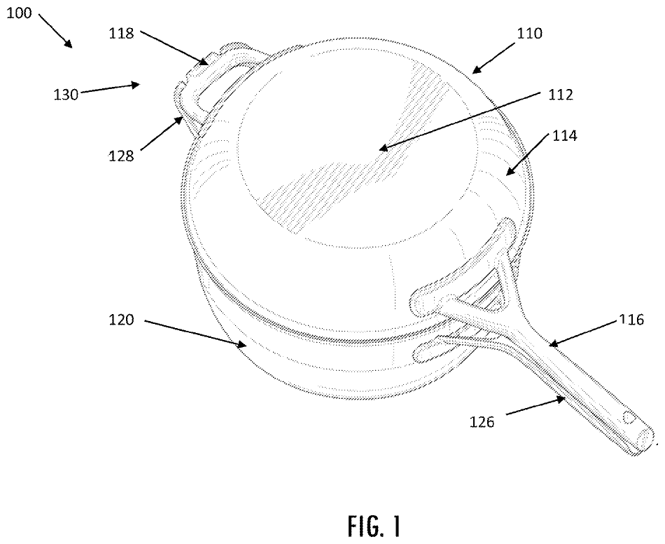

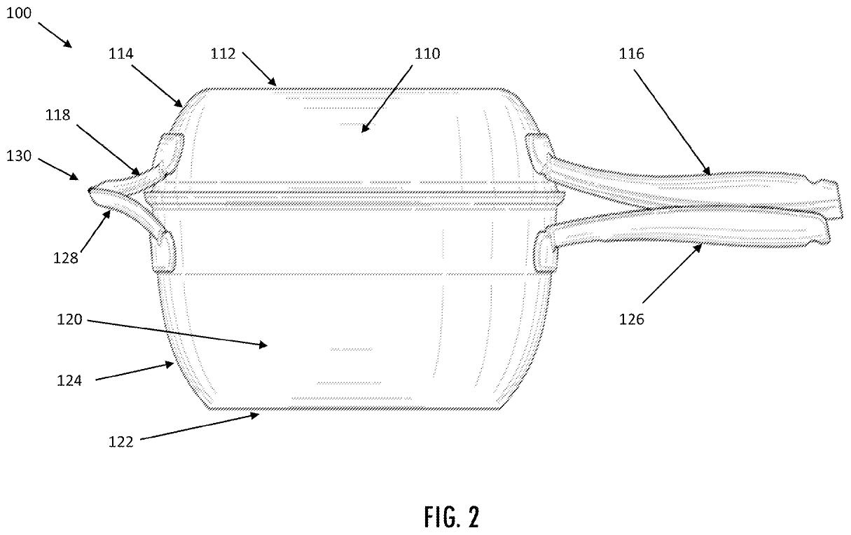

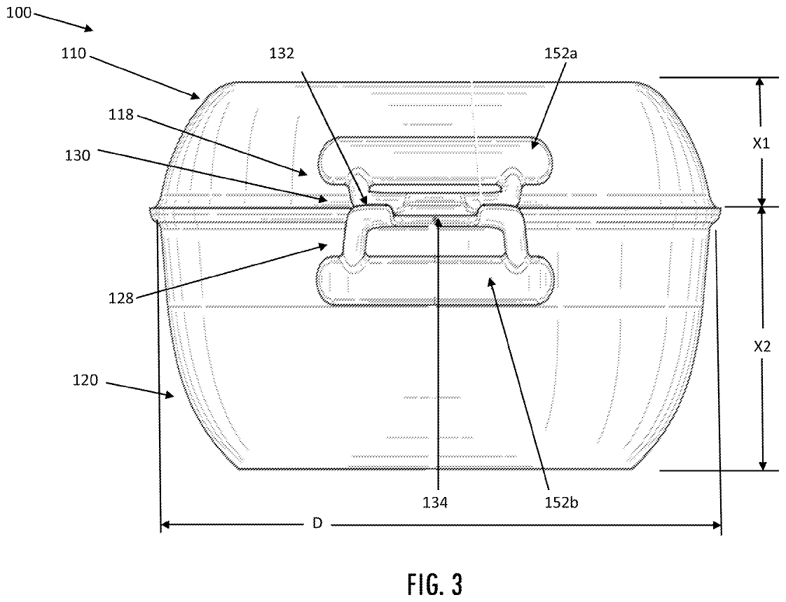

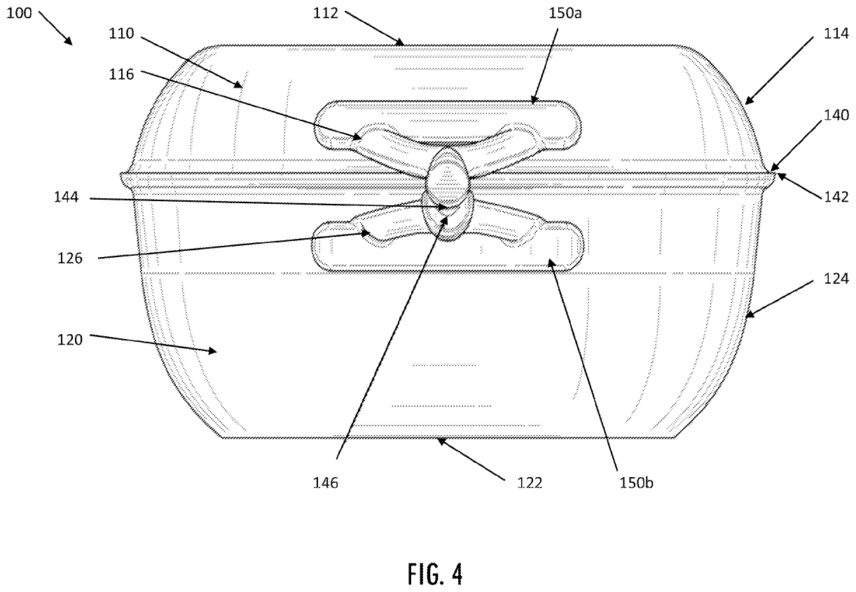

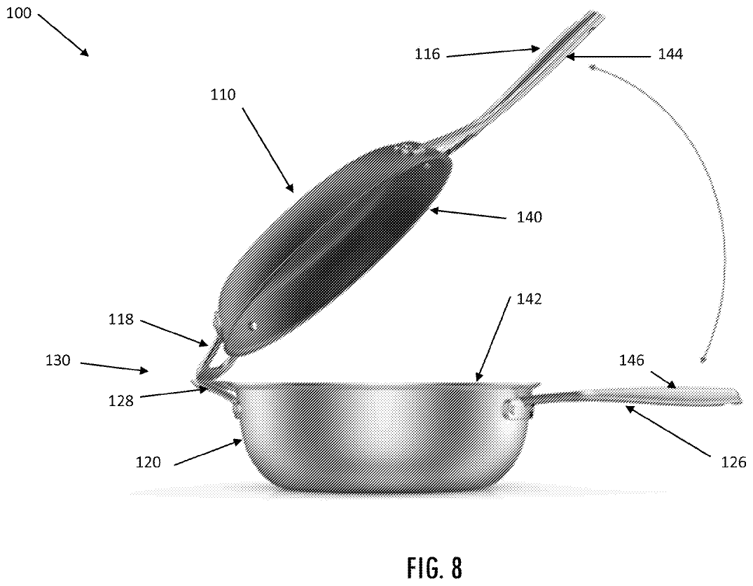

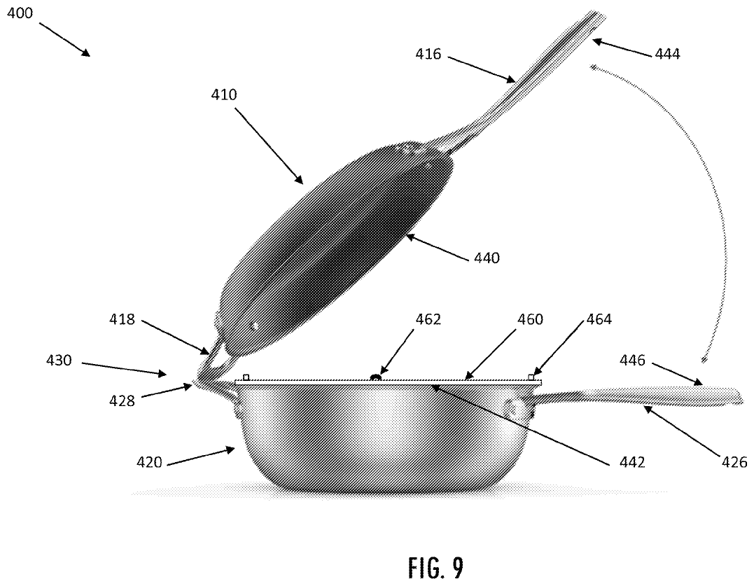

FIGS. 1-4 depict the improved combination cookware system 100 in a closed configuration, while FIGS. 8 and 9 depict the improved combination cookware system 100 in an open configuration as described in greater detail below. The system 100 includes a first portion 110, such as a skillet, and a second portion 120, such as an everyday fry/sauté pan. In some cases, the first and second portions are referred to collectively as “pans” and the second portion may be referred to as a hybrid pot. Each of the first and second portions 110, 120 include a cooking surface 112, 122 and a raised edge 114, 124 extending from their respective cooking surfaces 112, 122. The raised edges 114, 124 extend along a perimeter or a circumference of their respective portions 110, 120. Based on the orientation shown in FIGS. 1-4, the raised edge 114 of the first portion 110 extends downwardly from the cooking surface 110, while the raised edge 124 of the second portion 120 extends upwardly from its cooking surface 122. The first and second portions 110, 120 shown have generally dome-like shapes with circular openings; however, the shape of the portions and their respective openings can vary to suit a particular application and may include round, ovoid, polygonal, or combinations thereof, so long as the raised edges 114, 124 are generally aligned in the closed configuration, as described herein.

The first and second portions 110, 120 each include a gripping handle 116, 126 engaged with and extending outwardly from their respective raised edges 114, 124. The gripping handles 116, 126 may include flanges 150a, 150b for coupling to their respective portions via, for example, rivets, screws, or welding. In addition, the first and second portions 110, 120 each include a pivot handle 118, 128 engaged with and extending outwardly from their respective raised edges 114, 124. The pivot handles 118, 128 are typically located opposite of (i.e., diametrically opposed to) the gripping handles 116, 126; however, their positioning may vary to suit a particular application. The pivot handles 118, 128 may also include flanges 152a, 152b for coupling to their respective portions via, for example, rivets, screws, or welding.

The first portion 110 and the second portion 120 are engageable with one another to form the combination cookware system 100, which in some embodiments acts as a dutch oven. In some embodiments, the first portion 110 and the second portion 120 are engageable such that the raised edges 114, 124 of the first and second portions are in at least partial contact with one another or are close enough together that there is essential little to no gap between the two edges 114, 124. In some embodiments, a slight gap may be present to allow for, for example, venting from the closed cookware system 100. Additionally, the raised edges 114, 124 may include substantially flat top surfaces 140, 142 however, in some embodiments, the top surfaces 140, 142 may include mating structure (e.g., a trough on one top surfaces and a rib on the other top surface that is sized and shaped to interface with the trough) to, for example, assist with engagement and alignment between the two portions 110, 120.

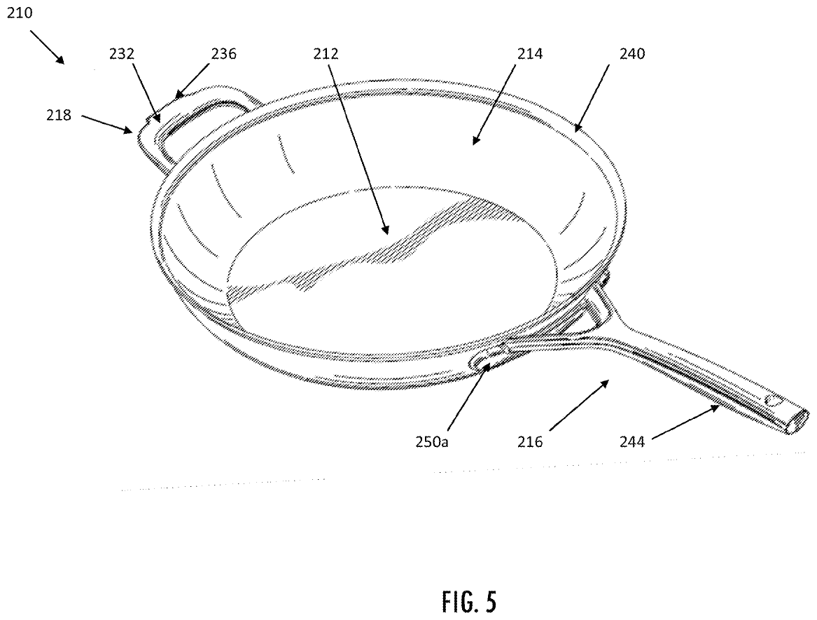

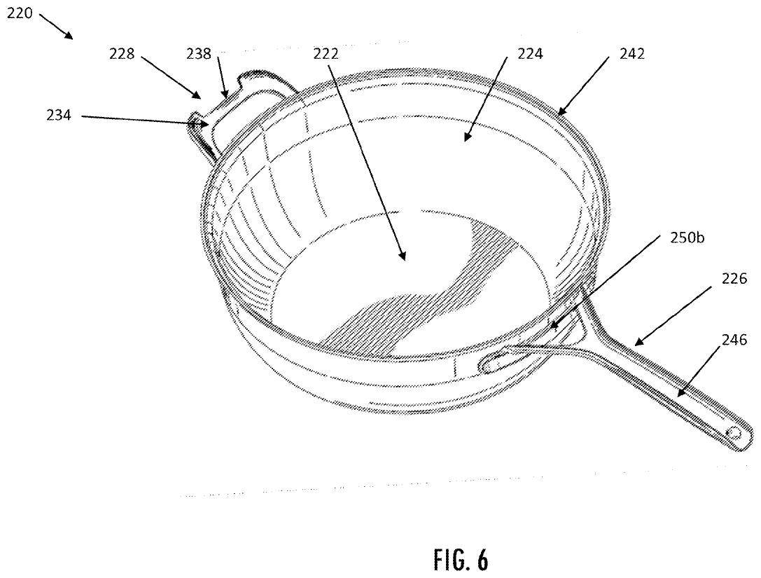

In this closed configuration, the gripping handles 116, 126 of the first and second portions 110, 120 are configured and arranged to nest with each other to form a unified and ergonomic gripping handle Nesting of the gripping handle 116 of the first portion 110 in the gripping handle 126 of the second portion 120 facilitates registration between the two portions and allows for the unified gripping handle to be gripped by one hand of the user. In some embodiments, the gripping handle 126 of the second portion 120 defines a recess 146 or similar structure on a top surface thereof (see also 246 in FIG. 5), while the gripping handle 116 of the first portion 110 has a protuberance 144 or similar structure on a bottom surface thereof (see also 244 in FIG. 6), where these two structures 144, 146 are sized and shape to be coupled together. In some embodiments, the gripping handles 116, 126 may be coupled together via a slight interference fit or a snap-fit such that handles 116, 126 tend to stay coupled until manually separated (e.g., a user lifts the top handle 116 to raise the first portion 110. In some additional examples, the gripping handle 116 of the first portion 110 may be longer than the gripping handle 126 of the second portion 120, so as to enable gripping of or interaction with just the gripping handle 116 of the first portion 110 in order to move the first portion 110 relative to the second portion 120 and/or to pivot the first portion 110 away from the second portion 120.

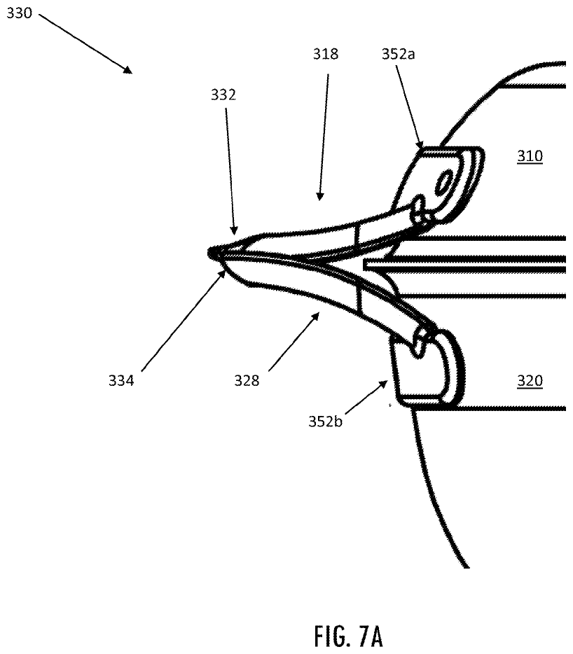

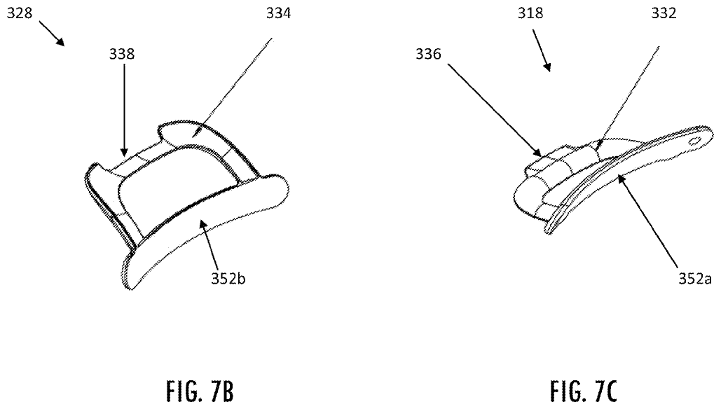

Also in the closed configuration, the pivot handles 118, 128 of the first and second portions 110, 120 are configured and arranged to engage with one another to form a type of pivot joint or engagement portion 130. The pivot joint 130 allows for the gripping handle 116 of the first portion 110 to be moved away from the gripping handle 126 of the second portion 120 into an open configuration, while maintaining registration between the two pivot handles 118, 128. The structure and registration between the two pivot handles are shown and described in greater detail with respect to FIGS. 7A-7C.

FIGS. 5 and 6 depict embodiments of individual cookware portions 210, 220 in greater detail. As shown in FIG. 5, the first portion 210 is shown in an inverted orientation insofar as the “bottom” of the cookware is depicted versus the orientation shown in FIGS. 1-4. The first portion 210 has a generally shallow, dome shape; however, other shapes are contemplated and considered within the scope of the invention. The first portion 210 includes a cooking surface 212 with a raised edge 214 extending upwardly therefrom (downward relative to its assembled orientation) and terminating at a top surface 240 thereof. The raised edge 214 has a generally curved shape; however, the raised edge 214 could have a substantially vertical planar shape to suit a particular application. The first portion 210 also includes a gripping handle 216 and a pivot handle 218 arranged as described above with respect to first portion 110. The gripping handle 216 is attached to the raised edge 214 via a flange 250a and includes structure 244 configured to mate with a corresponding structure on another handle. The pivot handle 218 extends from the raised edge 214 opposite of the gripping handle 216 and is also attached via a flange (not shown). The pivot handle 218 also includes structure 232 configured to mate with a corresponding structure on another handle to form a pivot joint. In some embodiments, the pivot handle 218 includes additional structure 236 for engaging and/or securing itself to the other pivot handle.

FIG. 6 depicts a second portion 220 with a generally dome shape, typically deeper than the dome of the first portion of FIG. 5. However, as with the first portion 210, other shapes are contemplated and considered within the scope of the invention. The second portion 220 includes a cooking surface 222 with a raised edge 224 extending upwardly therefrom and terminating at a top surface 242 thereof. The raised edge 224 has a generally curved shape; however, the raised edge 224 could also have a substantially vertical planar shape to suit a particular application. The second portion 220 also includes a gripping handle 226 and a pivot handle 228 arranged as described above with respect to second portion 120. The gripping handle 226 is attached to the raised edge 224 via a flange 250b and includes structure 246 configured to mate with a corresponding structure on another handle. The pivot handle 228 extends from the raised edge 224 opposite of the gripping handle 226 and is also attached via a flange (not shown). The pivot handle 228 also includes structure 234 configured to mate with a corresponding structure on another handle to form a pivot joint. In some embodiments, the pivot handle 228 includes additional structure 238 for engaging and/or securing itself to the other pivot handle.

FIG. 7A is an enlarged view of the engagement portion/pivot joint 330 of a combination cookware system. As shown, the pivot handle 318 of the first, or upper, portion 310 engages the pivot handle 328 of the second, or lower, portion 320 to form a pivot joint, such as a ball and socket joint, a saddle joint, a hinge joint, a gliding joint, a condyloid joint, or the like. Generally, one pivot handle forms the stud portion of the joint, while the other handle forms the socket portion of the joint.

FIG. 7B depicts the pivot handle 328 of the second portion removed therefrom. FIG. 7C depicts the pivot handle 318 of the first portion 310 removed therefrom Similar to the handles described above, the handles 318, 328 may include flanges 352a, 352b for attaching the pivot handles to their respective portions. In some examples, a ball and socket joint may be formed by the interaction of the two pivot handles 318, 328. For example, the pivot handle 328 of the second portion may include a recessed flange or socket 334, which may receive and act as guide for a protuberance or stud 332 portion of the pivot handle 318 of the first portion. The interface between the pivot handles 318, 328 forms the pivot joint 330. The stud 332 rests in and is levered against the socket 334 during a pivoting action. In some embodiments, a protuberance or “tongue” 336 may also be present on the pivot handle 318 of the first portion, which can engage with a channel 338 on the pivot handle 328 of the second portion to further assist in the engagement and alignment between the two pivot handles 318, 328.

FIGS. 8 and 9 depict combination cookware systems in open configurations. As shown in FIG. 8, gripping handle 116 is raised relative to gripping handle 126, resulting in the raising of the first portion 110 relative to the second portion 120 and about the pivot joint 130.

The combination cookware system 400 of FIG. 9 is substantially similar to the system 100 of FIG. 8, but with a lid 460 incorporated therein. The lid 460 is universally sized to fit both the first portion 410 and the second portion 420. For example, the lid 460 may be configured and arranged to engage a top edge 440 of the raised edge of the first portion 410 or a top surface 442 of the raised edge of the second portion 420 opposite their respective cooking surfaces. As shown in FIG. 9, the lid 460 is engaged with the top surface 442 of the second portion 420 enclosing the second portion. The lid 460 includes structure 464 configured to engage the first portion 410, which allows the lid 460 to be arranged between the first portion 410 and the second portion 420, such that the lid 460 engages the raised edges of one or both the first and second portions 410, 420 and acts as a barrier between the two portions. Alternatively, the first portion 110, 410 may act as a lid to the second portion 120, 420 and vice versa.

In some embodiments, the first portion 110, 210 comprises a first material and the second portion 120, 220 comprises a second material, where the first and second materials may be the same material or different materials. In various embodiments, the first and/or second materials may be selected from carbon steel, cast iron, multi-ply stainless steel (e.g., 24 gauge, series 305, 316, or 410) with an aluminum (e.g., a 6061 or 1060 aluminum alloy) core, a ferrous metal with stainless steel cladding, copper, titanium and/or the like, with or without a non-stick coating.

In certain embodiments, for example where the first material is carbon steel and the second material is a multi-ply stainless, the portion comprising the carbon steel material acts as an energy source for the other portion comprising the multi-ply stainless steel material due to the conductive nature of the aluminum layer of multi-ply stainless steel and the heat retentive properties of carbon steel, cast iron, and/or other ferrous metals. The use of different materials between the first and second portions, promotes optimal cooking, for example, slow cooking, keeping food warm, etc., as needed and/or as appropriate.

The first and second portions, their handles, and other components thereof may be manufactured via any conventionally known manufacturing process, such as casting, forging, stamping, and machining, with or without a coating or a mechanical finishing treatment (e.g., polishing).

The size of the portions will vary to suit a particular application and may range from about 6 inches (in.) in diameter (D) to about 20 in. in diameter (D) (or equivalent area for non-circular cookware), including, for example, 8 in., 10, in., 12 in., and 14 in. The height (X1) of the raised edge 114 of the first portion may range from about 1.0 in to about 2.5 in., while the height (X2) of the raised edge 124 of the second portion may range from about 2.0 in. to about 4.0 in.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of system elements, it should be understood that those elements may be combined in other ways to accomplish the same objectives.

Furthermore, those skilled in the art should appreciate that the parameters and configurations described herein are exemplary and that actual parameters and/or configurations will depend on the specific application in which the systems and techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto; the disclosure may be practiced other than as specifically described.

1. A combination cookware system comprising:
a first portion comprising:
a cooking surface;
a raised edge extending downwardly from and about a perimeter of the cooking surface;
a gripping handle engaged with and extending outwardly from the raised edge; and
a pivot handle engaged with and extending outwardly from the raised edge opposite to the gripping handle, wherein a bottom surface of the pivot handle comprises a bearing stud;
a second portion configured to engage with the first portion and comprising:
a cooking surface;
a raised edge extending upwardly from and about a perimeter of the cooking surface;
a gripping handle engaged with and extending outwardly from the raised edge;
a pivot handle engaged with and extending outwardly from the raised edge opposite to the gripping handle, wherein a top surface of the pivot handle comprises a bearing socket configured to engage the bearing stud of the first portion pivot handle to form a pivoting joint;
wherein the pivot handles of the first and second portions are arranged to pivotably engage each other such that movement of the gripping handle of the first portion relative to the gripping handle of the second portion transitions the cookware system between a closed configuration and an open configuration.

2. The system of claim 1, wherein the gripping handles of the first and second portions are configured to nest with each other to form a unified gripping handle.

3. The system of claim 1, wherein the raised edge of the first portion engages the raised edge of the second portion in a closed configuration.

4. The system of claim 1, wherein the first portion is a skillet.

5. The system of claim 1, wherein the second portion is a pan.

6. The system of claim 1, wherein engagement of the first portion and the second portion forms a dutch oven in the closed configuration.

7. The system of claim 1, wherein the pivot handles of the first and second portions pivotably engage via at least one of a ball and socket joint, a saddle joint, a hinge joint, a gliding joint, or a condyloid joint.

8. The system of claim 1, wherein the gripping handle of the second portion comprises a longitudinal recess extending along at least a portion of a top surface of the gripping handle.

9. The system of claim 8, wherein the gripping handle of the first portion comprises a longitudinal protuberance extending along at least a portion of a bottom surface of the gripping handle, the protuberance configured to engage with the recess in the gripping handle of the second portion.

10. The system of claim 9, wherein the gripping handle of the first portion engages with the gripping handle of the second portion via a snap-fit.

11. The system of claim 1, wherein the gripping handle of the first portion has a length greater than a length of the gripping handle of the second portion.

12. The system of claim 1, further comprising a lid configured to engage at least one of the raised edge of the first portion opposite to the cooking surface, the raised edge of the second portion opposite to the cooking surface, or both simultaneously.

13. The system of claim 1, wherein the first portion comprises a first material and the second portion comprises a second material.

14. The system of claim 13, wherein the first material comprises at least one of carbon steel, cast iron, multi-ply stainless steel with an aluminum core, a ferrous metal with stainless steel cladding, or combinations thereof and the second material comprises at least one of carbon steel, cast iron, multi-ply stainless steel with an aluminum core, a ferrous metal with stainless steel cladding, or combinations thereof.

15. The system of claim 13, wherein the first and second materials are different materials.

16. The system of claim 15, wherein the first material comprises carbon steel and the second material comprises a multi-ply stainless steel.

17. The system of claim 1, wherein the first and second portions comprise corresponding circular shapes.

18. The system of claim 1, wherein the first and second portions comprise corresponding polygonal shapes.

19. An apparatus for cooking, the apparatus comprising:
a cooking surface;
a raised edge extending upwardly from and about a perimeter of the cooking surface;
a gripping handle engaged with and extending outwardly from the raised edge; and
a pivot handle engaged with and extending outwardly from the raised edge opposite to the gripping handle, wherein a top surface of the pivot handle comprises a bearing socket configured to pivotably engage a bearing stud to form a pivoting joint.

20. An apparatus for cooking, the apparatus comprising:
a cooking surface;
a raised edge extending upwardly from and about a perimeter of the cooking surface;
a gripping handle engaged with and extending outwardly from the raised edge; and
a pivot handle engaged with and extending outwardly from the raised edge opposite to the gripping handle, wherein a bottom surface of the pivot handle comprises a bearing stud configured to pivotably engage a bearing socket to form a pivoting joint.
